(19) United States
(12) Patent Application Publication
(10) Pub. No.: US 2025/0127668 A1
(43) Pub. Date: Apr. 24, 2025

(54) Self-Locking Wheelchair Attachment Device

(71) Applicant: Irene Gudiel, Trenton, NJ (US)

(72) Inventor: Irene Gudiel, Trenton, NJ (US)

(21) Appl. No.: 18/823,090

(22) Filed: Sep. 3, 2024

Related U.S. Application Data
(60) Provisional application No. 63/592,660, filed on Oct. 24, 2023.

(51) Int. Cl. A61G 5/10; B60T 7/12

(52) U.S. Cl. CPC A61G 5/101; A61G 5/1018; B60T 7/12

(57) ABSTRACT

A self-locking wheelchair device is disclosed that automatically brakes the wheel when the wheelchair is parked so patients don't have to worry about the wheelchair moving when they get out of the chair. The self-locking wheelchair device comprises a pressure sensitive pad that is configured in a rectangular shape and positioned in a seat of a conventional wheelchair. The pressure sensitive pad is in communication with a control box comprising a battery, a controller, and a motor. The control box is then in communication with at least one automatic brake assembly, such that when a user attempts to stand from a wheelchair, the brakes are automatically engaged. The device also includes a manual brake to override the automatic brake assemblies, as needed and a lock/release lever once the user has risen or been seated within the wheelchair, to disengage the automatic brake assemblies.

### CROSS-REFERENCE TO RELATED APPLICATION

The present application claims priority to, and the benefit of, U.S. Provisional Application No. 63/592,660, which was filed on Oct. 24, 2023, and is incorporated herein by reference in its entirety.

### FIELD OF THE INVENTION

The present invention relates generally to the field of self-locking wheelchair devices. More specifically, the present invention relates to a self-locking wheelchair attachment that automatically brakes the wheel when the wheelchair is parked, so patients don't have to worry about the wheelchair moving when they get out of the chair. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in self-locking wheelchair devices. Generally, when patients abruptly get up from a wheelchair, the wheelchair can suddenly shift positions, potentially leading to dangerous falls or injuries. Further, patients who struggle with impulsivity or cognitive issues tend to get up from wheelchairs unexpectantly or forget to lock the chair. This can lead to falls and injuries, such as hip fractures, head injuries, joint fractures, hospitalizations or loss of a loved one due to a fatal injury.

Furthermore, manual brake mechanisms allow either a user or an attendant to lock the wheels of the wheelchair when exiting, so that the chair does not move away when a patient attempts to enter or exit. Although the conventional manual brake mechanisms are sufficient for their intended purpose once engaged, the requirement that the user must remember to actuate the brakes leaves these devices susceptible to user error. For example, a conventional wheelchair will remain freely moveable if a user or attendant forgets to manually pivot the braking device and lock the wheels. The wheelchair may also remain freely moveable if a user or attendant does not fully apply the manual braking device to the wheels. As a result, a user attempting to stabilize himself or herself while entering or leaving the wheelchair, is at an increased risk of falling and injury due to the freely moveable wheelchair moving out from beneath them.

Accordingly, there is a demand for an improved self-locking wheelchair device that detects when a user leaves the chair and automatically engages the brake. More particularly, there is a demand for a self-locking wheelchair device that easy to install on a wide range of wheelchairs.

Therefore, there exists a long felt need in the art for a self-locking wheelchair device that is applied to a wheelchair to prevent the wheelchair from suddenly shifting positions. There is also a long felt need in the art for a self-locking wheelchair device that automatically prevents a wheelchair from moving when a user enters or exits the chair. Further, there is a long felt need in the art for a self-locking wheelchair device that includes a built-in sensor which detects when a user leaves the chair. Moreover, there is a long felt need in the art for a device that is easy to install on a wide range of wheelchairs. Further, there is a long felt need in the art for a self-locking wheelchair device that provides clear status messages so users know when to charge or replace the batteries. Finally, there is a long felt need in the art for a self-locking wheelchair device that is great for patients that struggle with impulsivity or cognitive issues.

The subject matter disclosed and claimed herein, in one embodiment thereof, comprises a self-locking wheelchair device. The device is a wheelchair attachment that automatically brakes the wheel when the wheelchair is parked so patients don't have to worry about the wheelchair moving when they get out of the chair. The self-locking wheelchair device comprises a pressure sensitive pad that is configured in a rectangular shape and positioned in a seat of a conventional wheelchair. The pressure sensitive pad is in communication with a control box comprising a battery, a controller, and a motor. The control box is then in communication with at least one automatic brake assembly, such that when a user attempts to stand from a wheelchair, the brakes are automatically engaged. The device also includes a manual brake to override the automatic brake assemblies, as needed and a lock/release lever once the user has risen or been seated within the wheelchair, to disengage the automatic brake assemblies.

In this manner, the self-locking wheelchair device of the present invention accomplishes all of the forgoing objectives and provides users with a device that easily installs within a wheelchair. The device includes a built-in sensor for engaging the brakes. The device provides status messages for the battery.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-locking wheelchair device. The device is a wheelchair attachment that automatically brakes the wheel when the wheelchair is parked so patients don't have to worry about the wheelchair moving when they get out of the chair. The self-locking wheelchair device comprises a pressure sensitive pad that is positioned in a seat of a conventional wheelchair. The pressure sensitive pad is in communication with a control box which controls the engaging and disengaging of at least one automatic brake assembly, such that when a user attempts to stand from a wheelchair, the brakes are automatically engaged.

In one embodiment, the self-locking wheelchair device is mounted to a conventional wheelchair. Advantageously, the structures and components of the wheelchair need not be modified or removed to accommodate the self-locking wheelchair device, and the device is configured to be mountable to essentially any conventional wheelchair, including those designed to be collapsible. In another embodiment, the self-locking wheelchair device is not an add-on but manufactured with the wheelchair at the point of manufacture as a singular unit.

In one embodiment, the self-locking wheelchair device is applied to a conventional wheelchair. Conventional wheelchairs typically comprise a frame, a seat and a backrest, and a pair of manual brake mechanisms. Two large drive wheels are typically rotatably mounted to the frame to permit a user to operate and move the wheelchair. The manually operated hand brakes are coupled to the wheelchair to engage and prevent rotational movement of the drive wheels. Further, conventional wheelchairs also typically include leg rests and armrests for the comfort of the user.

The self-locking wheelchair device is generally easily retrofittable to an existing wheelchair frame. The device may be movable between an engaged position that generally inhibits rolling movement of the wheelchair and a disengaged position permitting free rolling movement of the wheelchair in response to movement of the user standing up or sitting down in the wheelchair. Specifically, the device is movable between a first position when the wheelchair is occupied and a second position when the wheelchair is unoccupied.

In one embodiment, the self-locking wheelchair device comprises a pressure sensitive pad that is configured in a rectangular or square shape to fit within the seat of a conventional wheelchair. The pressure sensitive pad can be any suitable shape and size as is known in the art, as long as it fits within the wheelchair seat, and is suitable for patients at fall risk with no weight minimum or maximum. The pressure sensitive pad is any conventional pressure sensor that detects when pressure is applied and removed from the pad. Consequently, if contact is maintained with the seat, the pressure sensitive pad communicates with a control box to apply or disengage the brakes. Specifically, the pressure sensitive pad is operably coupled to the control box and positionable on the seat to sense when a user is entering or leaving the wheelchair. In one example embodiment, as a user enters the wheelchair the pressures sensitive pad engages the seat and travels in a downward vertical direction. The downward movement of the pressure sensitive pad causes the control box to communicate with the controller and the motor to pivot or rotate the brake assembly from the engaged position toward the disengaged position. In the engaged position, the drive wheel is locked and not freely rotatable. With the user seated, the brake assembly is disengaged. In the disengaged position, the wheelchair is freely moveable.

In one embodiment, the control box comprises a controller and a battery, as well as various function buttons. The controller communicates with the pressure sensitive pad and motors. The motors are typically housed with the brake assemblies but could also be housed within the control box. Thus, when the pressure sensitive pad senses a user standing up from the wheelchair, the pressure sensitive pad communicates with the controller. The controller then communicates with the motors to engage the brake assemblies and prevent the wheelchair from moving. Further, the control box includes a power on/off switch and a USB charging port for charging the battery (i.e., lithium battery).

In one embodiment, the lithium battery within the control box is rechargeable or replaceable and acts to power the controller and motors. During use, status messages are sent to user's smart devices or indicator lights and/or audible alarms are alerted on the control box, so that a user knows when to charge or change the battery. The rechargeable or replaceable battery can also have a battery backup (i.e., AA battery or other suitable battery), to prevent injury from the brakes not engaging.

In one embodiment, the required wiring, cords, or other means of communicating with/connecting the device components is secured to the frame of the wheelchair via Velcro straps, snaps, clasps, staples, etc., or any other suitable securing means as is known in the art. For purposes of this document, a connection may be a direct connection or an indirect connection (i.e., via intervening elements). Two components are “in communication” if they are directly or indirectly connected so that they can communicate electronic signals between them.

In one embodiment, the brake assemblies are positioned near the drive wheels of the wheelchair and comprise a clamp or lever which engage the drive wheels of the wheelchair. Specifically, the lever pivots about a vertical axis relative to the wheelchair, and the lever is then adapted to engage the drive wheels of the wheelchair. To disengage, the levers are then rotated downwardly into a disengaged position. The lever comprises a generally arcuate shape which provides more surface contact between the lever and the drive wheel, thereby increasing rotational resistance. Typically, only one brake assembly is necessary to accomplish the desired braking function of the wheelchair. However, it is most common to pair a first and a second brake assembly with the opposing drive wheels.

In one embodiment, the brake assembly is motor driven and has a default engaged position. In this embodiment, the motor is disposed with the brake assembly near the drive wheel. The brake assembly includes a shaft and a lever. Thus, the brake assembly is in communication with a motor, such that the brake assembly is activated when there is no electricity. This means that it doesn't take any energy to hold the motor shaft still and engage the brake assembly, but instead it takes energy to release the motor to turn the shaft and disengage the brake assembly. This reduces energy consumption for the device. In the engaged position, the lever of the brake assembly is disposed adjacent to and confronts a portion of the drive wheel, preventing it from rotating freely. In the disengaged position, the lever is disposed a sufficient distance away from the drive wheel, to allow it to freely rotate. Further the brake assemblies are in communication with the pressure sensitive pad which detects user movement and communicates with the brake assemblies to facilitate rotational movement or pivoting of the lever from the engaged position toward the disengaged position when a user is entering or leaving the wheelchair. Accordingly, the motor spins the shaft clockwise and the lever engages the drive wheel of the wheelchair. Further, the motor spins the shaft counter-clockwise and the lever disengages from the drive wheel. Further, by having the engaged position as the default position, the drive wheels remain locked when the user is not seated, thereby immobilizing the wheelchair and providing a stable structure for the user. Since the wheelchair is immobilized, a user entering or leaving the seat of the wheelchair will have a significantly reduced chance of falling due to the wheelchair coming out from under them.

In one embodiment, the self-locking wheelchair device comprises at least one lock/release lever that is typically secured to a handle of the wheelchair. The lock/release levers enable the brake assemblies to be disengaged or engaged with their wheels. Each lock/release lever is mounted to a handle of the wheelchair and in communication with the control box. With this configuration, the lock/release levers can engage or disengage the brake assemblies, as needed. Further, the at least one lock/release lever is pivotally couplable to the handle of the wheelchair. Specifically, a linkage is coupled to and extends between the lock/release lever and the control box which communicates with the brake assemblies. The lock/release lever is pivotable between a depressed position or state and released position or state to lock or release the drive wheels of the wheelchair. The lock/release lever may be manufacture from stainless steel. Additionally, the lock/release lever may have a generally textured outer surface and/or a contoured surface to facilitate gripping and/or comfort for a user grasping the lever. Other configurations, materials and texturing are also contemplated by the present invention. Other materials may include aluminum, composite, polymer, or similar materials. Additionally, the lock/release lever may have a silver ion coating, which has been shown to kill bacteria, viruses and other pathogens.

In one embodiment, the self-locking wheelchair device comprises a manual brake mechanism which allows either a user or an attendant to manually lock the wheels of the wheelchair when exiting, so that the chair does not move away when a patient attempts to enter or exit. For example, if the device does not activate and/or does not engage the brake assemblies, the manual brake mechanism can be engaged to override the automatic brake assemblies. A user merely turns the handle which turns the shaft (instead of the motor turning it) to engage a lever which engages the wheel to prevent the wheelchair from moving.

In operation, whenever the wheelchair is occupied, the pressure sensitive pad on the seat is urged downward, setting off the sensors to disengage the brake assemblies. Then, when the user rises from the seat, the pressure sensitive pad rises with the seat, which in turn engages the brake assemblies. When pressure is removed from the sensor pad, an alert is sent to a caregiver. In addition to its uncomplicated operation, the self-locking wheelchair device can also be seen to have an uncomplicated construction, which promotes the ease with which the device can be installed on essentially any conventional wheelchair.

In yet another embodiment, the self-locking wheelchair device comprises a plurality of indicia.

In yet another embodiment, a method of automatically locking a wheelchair when a user attempts to stand is disclosed. The method includes the steps of providing a self-locking wheelchair device comprising a pressure sensitive pad in communication with a control box and brake assemblies. The method also comprises positioning the pressure sensitive pad on a wheelchair seat and securing the control box and brake assemblies to the wheelchair. Further, the method comprises sitting a user within the wheelchair on the pressure sensitive pad. The method also comprises automatically engaging the brake assemblies when the user attempts to stand up from the wheelchair. Finally, the method comprises disengaging the brake assemblies when the user sits back down via the lock/release lever on the handle.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a perspective view of one embodiment of the self-locking wheelchair device of the present invention showing the device secured to a wheelchair in accordance with the disclosed architecture;

FIGS. 2-3 illustrate a perspective view of one embodiment of the self-locking wheelchair device of the present invention showing the brake assemblies in accordance with the disclosed architecture;

FIGS. 4-5 illustrate a perspective view of one embodiment of the self-locking wheelchair device of the present invention showing the control box in accordance with the disclosed architecture;

FIGS. 6-7 illustrate a perspective view of one embodiment of the self-locking wheelchair device of the present invention showing the lock/release lever in accordance with the disclosed architecture;

FIGS. 8 and 9A-B illustrate a perspective view of one embodiment of the self-locking wheelchair device of the present invention showing the components of the device in accordance with the disclosed architecture;

FIGS. 10A-E illustrate a perspective view of one embodiment of the self-locking wheelchair device of the present invention showing the device components applied to a wheelchair in accordance with the disclosed architecture;

FIGS. 11A-F illustrate a perspective view of one embodiment of the self-locking wheelchair device of the present invention showing the brake assemblies in accordance with the disclosed architecture;

FIG. 12 illustrates a perspective view of one embodiment of the self-locking wheelchair device of the present invention showing the manual brake in accordance with the disclosed architecture; and

FIG. 13 illustrates a flowchart showing the method of automatically locking a wheelchair when a user attempts to stand in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a self-locking wheelchair device that is applied to a wheelchair to prevent the wheelchair from suddenly shifting positions. There is also a long felt need in the art for a self-locking wheelchair device that automatically prevents a wheelchair from moving when a user enters or exits the chair. Further, there is a long felt need in the art for a self-locking wheelchair device that includes a built-in sensor which detects when a user leaves the chair. Moreover, there is a long felt need in the art for a device that is easy to install on a wide range of wheelchairs. Further, there is a long felt need in the art for a self-locking wheelchair device that provides clear status messages so users know when to charge or replace the batteries. Finally, there is a long felt need in the art for a self-locking wheelchair device that is great for patients that struggle with impulsivity or cognitive issues.

The present invention, in one exemplary embodiment, is a novel self-locking wheelchair device. The self-locking wheelchair device comprises a pressure sensitive pad that is configured in a rectangular shape and positioned in a seat of a conventional wheelchair. The pressure sensitive pad is in communication with a control box comprising a battery, a controller, and a motor. The control box is then in communication with at least one automatic brake assembly, such that when a user attempts to stand from a wheelchair, the brakes are automatically engaged. The device also includes a manual brake to override the automatic brake assemblies, as needed and a lock/release lever once the user has risen or been seated within the wheelchair, to disengage the automatic brake assemblies. The present invention also includes a novel method of automatically locking a wheelchair when a user attempts to stand. The method includes the steps of providing a self-locking wheelchair device comprising a pressure sensitive pad in communication with a control box and brake assemblies. The method also comprises positioning the pressure sensitive pad on a wheelchair seat and securing the control box and brake assemblies to the wheelchair. Further, the method comprises sitting a user within the wheelchair on the pressure sensitive pad. The method also comprises automatically engaging the brake assemblies when the user attempts to stand up from the wheelchair. Finally, the method comprises disengaging the brake assemblies when the user sits back down via the lock/release lever on the handle.

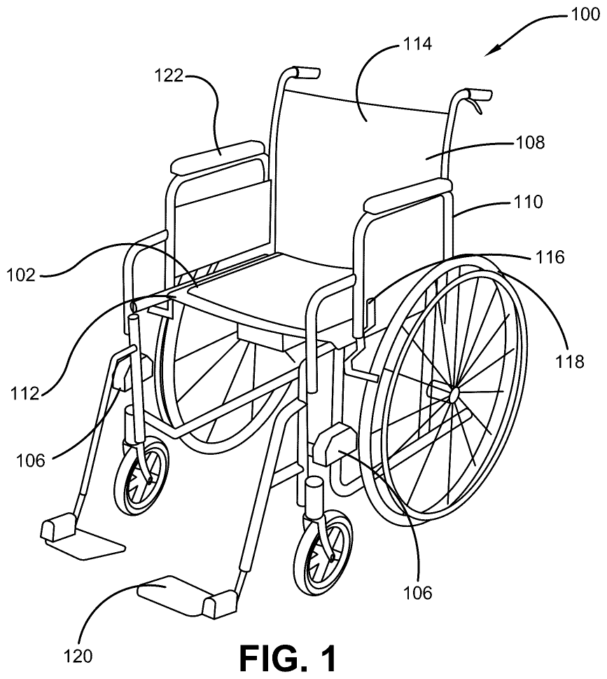

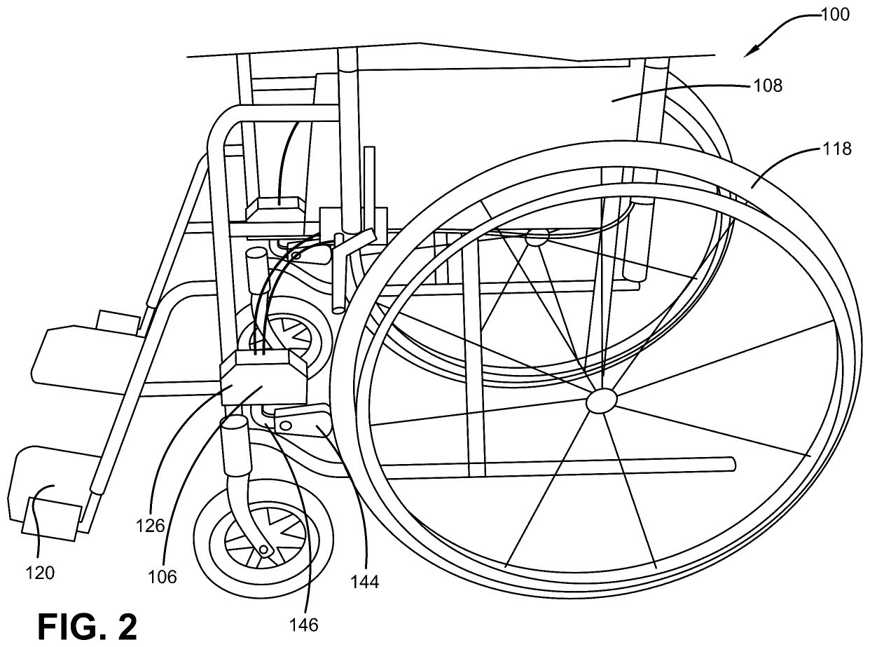

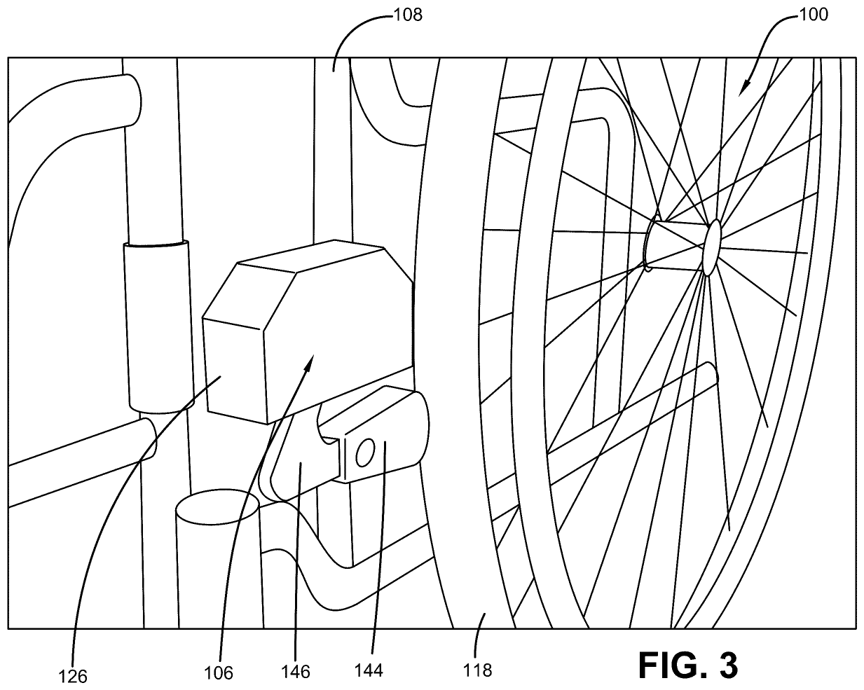

Referring initially to the drawings, FIGS. 1-3 illustrate a perspective view of one embodiment of the self-locking wheelchair device 100 of the present invention. In the present embodiment, the self-locking wheelchair device 100 is a wheelchair attachment that automatically locks a wheelchair 108 when a user attempts to stand up. Specifically, the self-locking wheelchair device 100 comprises a pressure sensitive pad 102 in communication with a control box 104 and at least one brake assembly 106. The control box 104 controls the engaging and disengaging of the at least one automatic brake assembly 106, such that when a user attempts to stand from a wheelchair 108, the brakes 106 are automatically engaged.

Generally, the self-locking wheelchair device 100 is mounted to a conventional wheelchair 108. Advantageously, the structures and components of the wheelchair 108 need not be modified or removed to accommodate the self-locking wheelchair device 100, and the device 100 is configured to be mountable to essentially any conventional wheelchair 108, including those designed to be collapsible. In another embodiment, the self-locking wheelchair device 100 is not an add-on but manufactured with the wheelchair 108 at the point of manufacture as a singular unit.

Further, the self-locking wheelchair device 100 is applied to a conventional wheelchair 108. Conventional wheelchairs 108 typically comprise a frame 110, a seat 112 and a backrest 114, and a pair of manual brake mechanisms 116. Two large drive wheels 118 are typically rotatably mounted to the frame 110 to permit a user to operate and move the wheelchair 108. The manually operated hand brakes 116 are coupled to the wheelchair 108 to engage and prevent rotational movement of the drive wheels 118. Further, conventional wheelchairs 108 also typically include leg rests 120 and armrests 122 for the comfort of the user.

The self-locking wheelchair device 100 is generally easily retrofittable to an existing wheelchair frame 110. The device 100 may be movable between an engaged position that generally inhibits rolling movement of the wheelchair 108 and a disengaged position permitting free rolling movement of the wheelchair 108 in response to movement of the user standing up or sitting down in the wheelchair 108. Specifically, the device 100 is movable between a first position when the wheelchair 108 is occupied and a second position when the wheelchair 108 is unoccupied.

Furthermore, the self-locking wheelchair device 100 comprises a pressure sensitive pad 102 that is configured in a rectangular or square shape to fit within the seat 112 of a conventional wheelchair 108. The pressure sensitive pad 102 can be any suitable shape and size as is known in the art, as long as it fits within the wheelchair seat 112, and is suitable for patients at fall risk with no weight minimum or maximum. The pressure sensitive pad 102 is any conventional pressure sensor that detects when pressure is applied and removed from the pad 102. Consequently, if contact is maintained with the seat 112, the pressure sensitive pad 102 communicates with a control box 104 to apply or disengage the brakes 106. Specifically, the pressure sensitive pad 102 is operably coupled to the control box 104 and positionable on the seat 112 to sense when a user is entering or leaving the wheelchair 108. In one example embodiment, as a user enters the wheelchair 108 the pressures sensitive pad 102 engages the seat 112 and travels in a downward vertical direction. The downward movement of the pressure sensitive pad 102 causes the control box 104 to communicate with the controller 124 and the motor 126 to pivot or rotate the brake assembly 106 from the engaged position toward the disengaged position. In the engaged position, the drive wheel 118 is locked and not freely rotatable. With the user seated, the brake assembly 106 is disengaged. In the disengaged position, the wheelchair 108 is freely moveable.

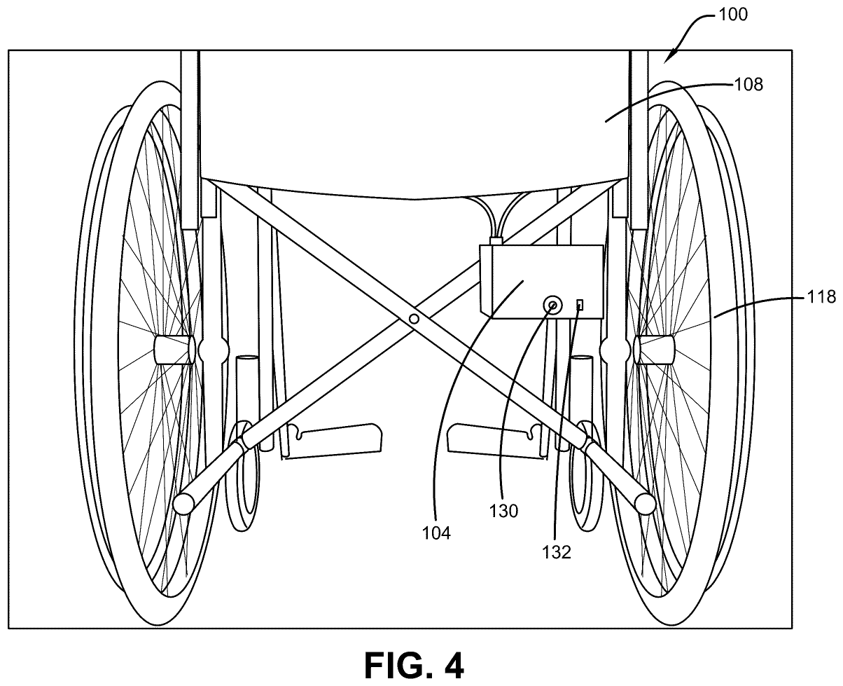

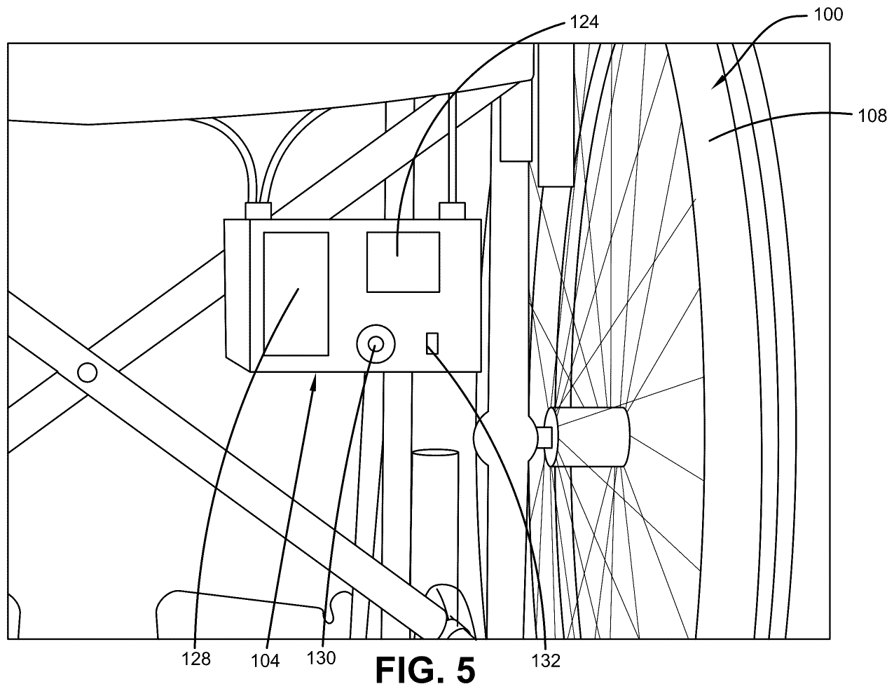

As shown in FIGS. 4-5, the control box 104 comprises a controller 124 and a battery 128, as well as various function buttons 130. The controller 124 communicates with the pressure sensitive pad 102 and motors 126. The motors 126 are typically housed with the brake assemblies 106 but could also be housed within the control box 104. Thus, when the pressure sensitive pad 102 senses a user standing up from the wheelchair 108, the pressure sensitive pad 102 communicates with the controller 124. The controller 124 then communicates with the motors 126 to engage the brake assemblies 106 and prevent the wheelchair 108 from moving. Further, the control box 104 includes a power on/off switch 130 and a USB charging port 132 for charging the battery 128 (i.e., lithium battery).

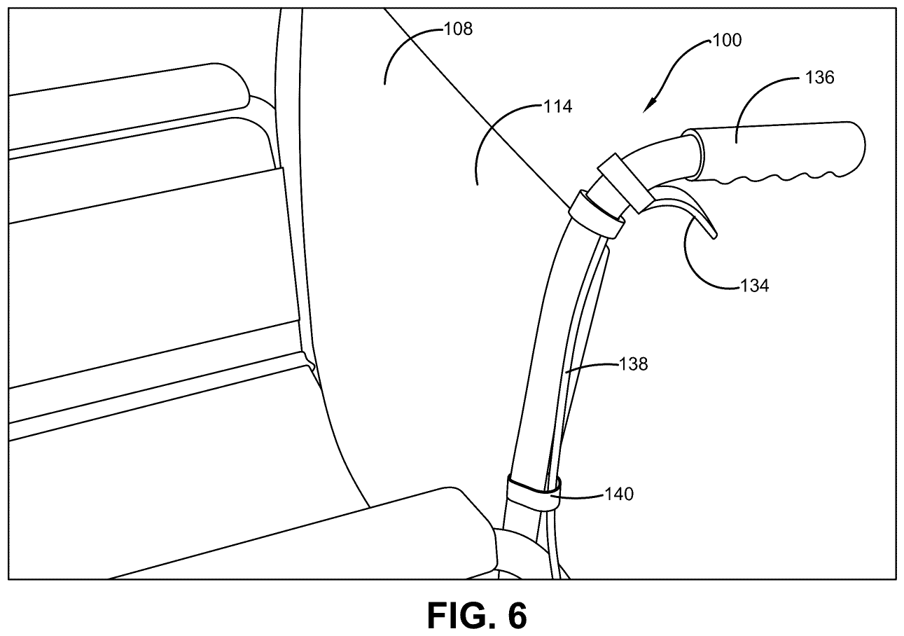

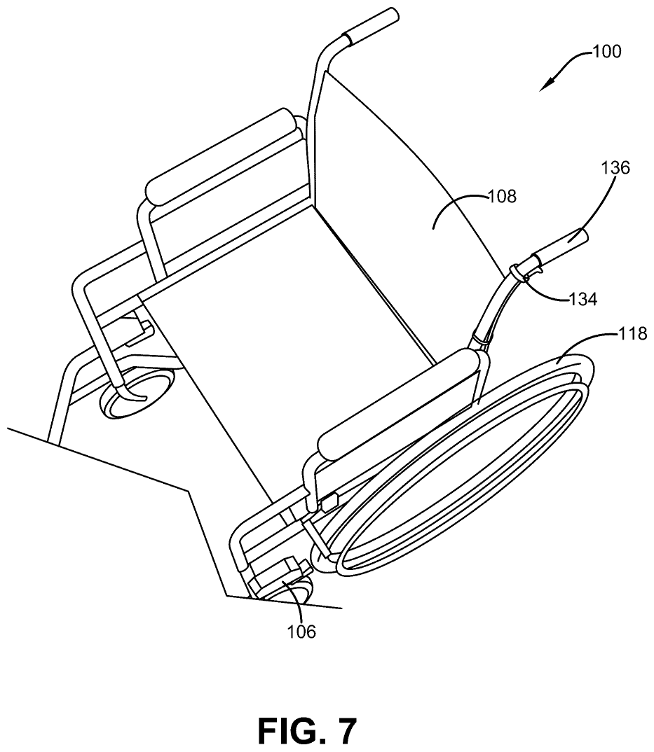

As shown in FIGS. 6-7, the self-locking wheelchair device 100 comprises at least one lock/release lever 134 that is typically secured to a handle 136 of the wheelchair 108. The lock/release levers 134 enable the brake assemblies 106 to be disengaged or engaged with their wheels 118. Each lock/release lever 134 is mounted to a handle 136 of the wheelchair 108 and in communication with the control box 104. With this configuration, the lock/release levers 134 can engage or disengage the brake assemblies 106, as needed. Further, the at least one lock/release lever 134 is pivotally couplable to the handle 136 of the wheelchair 108. Specifically, a linkage 138 is coupled to and extends between the lock/release lever 134 and the control box 104 which communicates with the brake assemblies 106. The lock/release lever 134 is pivotable between a depressed position or state and released position or state to lock or release the drive wheels 118 of the wheelchair 108. The lock/release lever 134 may be manufacture from stainless steel. Additionally, the lock/release lever 134 may have a generally textured outer surface and/or a contoured surface to facilitate gripping and/or comfort for a user grasping the lever 134. Other configurations, materials and texturing are also contemplated by the present invention. Other materials may include aluminum, composite, polymer, or similar materials. Additionally, the lock/release lever 134 may have a silver ion coating, which has been shown to kill bacteria, viruses and other pathogens.

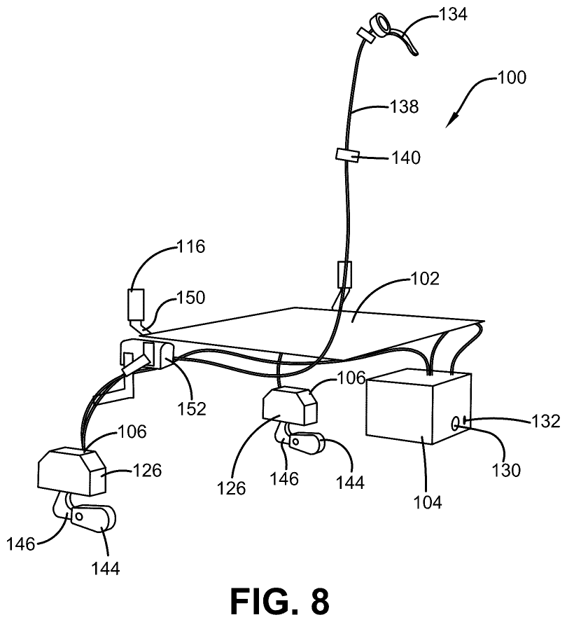

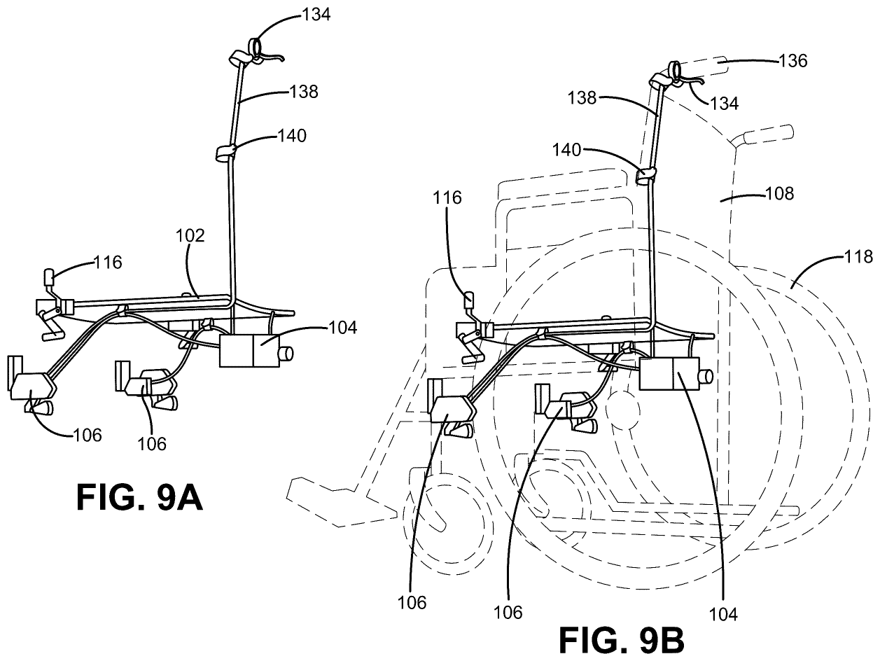

As shown in FIGS. 8 and 9A-B, the lithium battery 128 within the control box 104 is rechargeable or replaceable and acts to power the controller 124 and motors 126. During use, status messages are sent to user's smart devices or indicator lights and/or audible alarms are alerted on the control box 104, so that a user knows when to charge or change the battery 128. The rechargeable or replaceable battery 128 can also have a battery backup (i.e., AA battery or other suitable battery), to prevent injury from the brakes 106 not engaging.

The battery 128 may be a disposable battery or a rechargeable battery in the form of an alkaline, nickel-cadmium, nickel-metal hydride battery, etc., such as any 3V-12volts DC battery or other conventional battery, such as A, AA, AAA, etc., that supplies power to the self-locking wheelchair device 100. Throughout this specification, the term “battery” may be used interchangeably to refer to one or more wet or dry cells or batteries of cells in which chemical energy is converted into electricity and used as a source of DC power. References to recharging or replacing the battery 128 may refer to recharging or replacing individual cells, individual batteries of cells, or a package of multiple battery cells as is appropriate for any given battery technology that may be used. In addition, a rechargeable embodiment of the battery 128 may be recharged using a USB port (not shown), wherein the USB port is a USB-A, USB-B, Micro-B, Micro-USB, Mini-USB, or USB-C port, etc.

Further, the required wiring (i.e., linkages 138), cords, or other means of communicating with/connecting the device components is secured to the frame 110 of the wheelchair 108 via Velcro straps 140, snaps, clasps, staples, etc., or any other suitable securing means as is known in the art. For purposes of this document, a connection may be a direct connection or an indirect connection (i.e., via intervening elements). Two components are “in communication” if they are directly or indirectly connected so that they can communicate electronic signals between them.

In yet another embodiment, the self-locking wheelchair device 100 comprises a plurality of indicia 142. The pressure sensitive pad 102 of the device 100 may include advertising, a trademark, or other letters, designs, or characters, printed, painted, stamped, or integrated into the pressure sensitive pad 102, or any other indicia 142 as is known in the art. Specifically, any suitable indicia 142 as is known in the art can be included, such as but not limited to, patterns, logos, emblems, images, symbols, designs, letters, words, characters, animals, advertisements, brands, etc., that may or may not be wheelchair, brakes, or brand related.

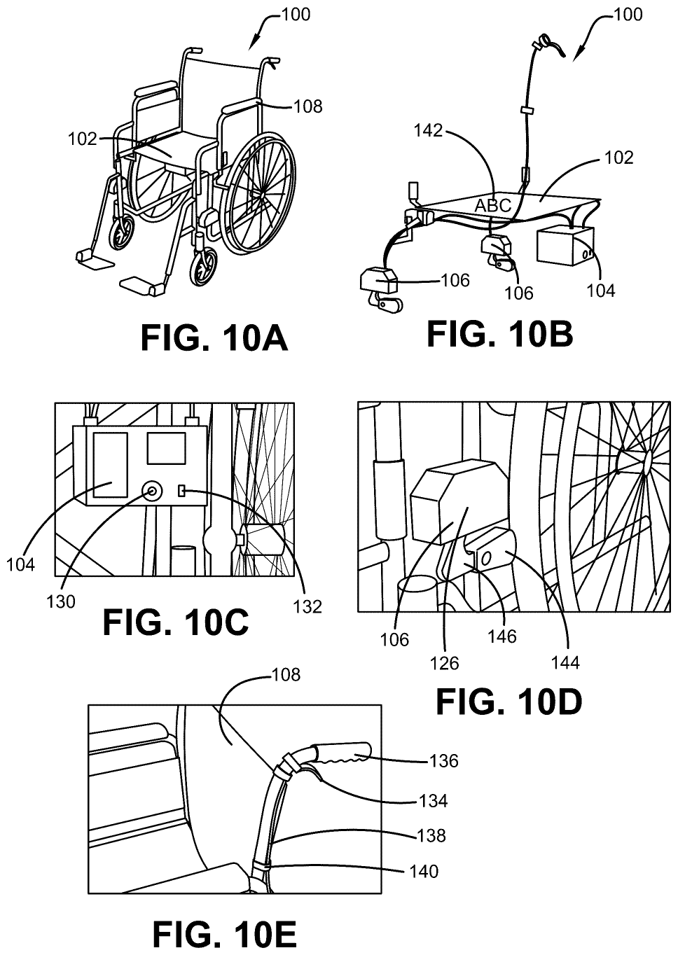

As shown in FIGS. 10A-E, in operation, whenever the wheelchair 108 is occupied, the pressure sensitive pad 102 on the seat 112 is urged downward, setting off the sensors to disengage the brake assemblies 106. Then, when the user rises from the seat 112, the pressure sensitive pad 102 rises with the seat 112, which in turn engages the brake assemblies 106. In addition to its uncomplicated operation, the self-locking wheelchair device 100 can also be seen to have an uncomplicated construction, which promotes the ease with which the device 100 can be installed on essentially any conventional wheelchair 108.

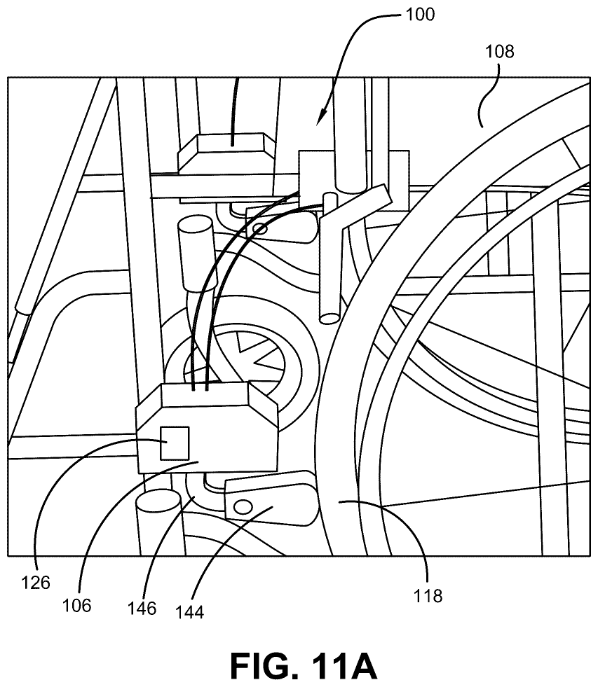

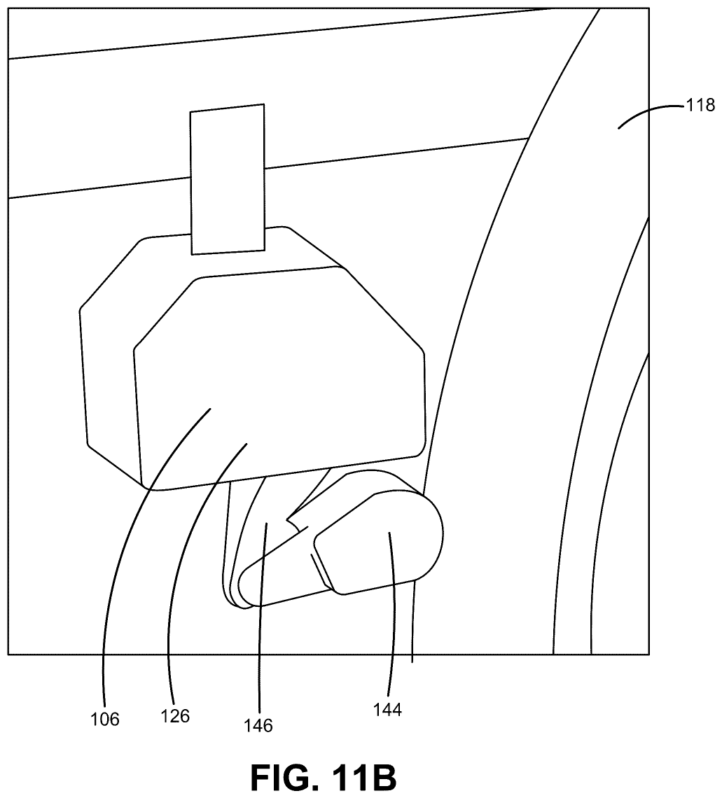

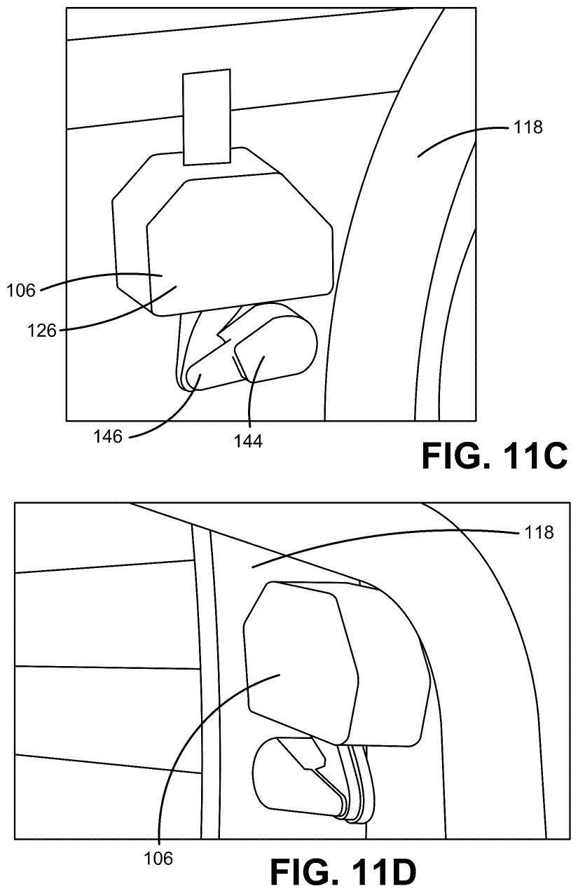

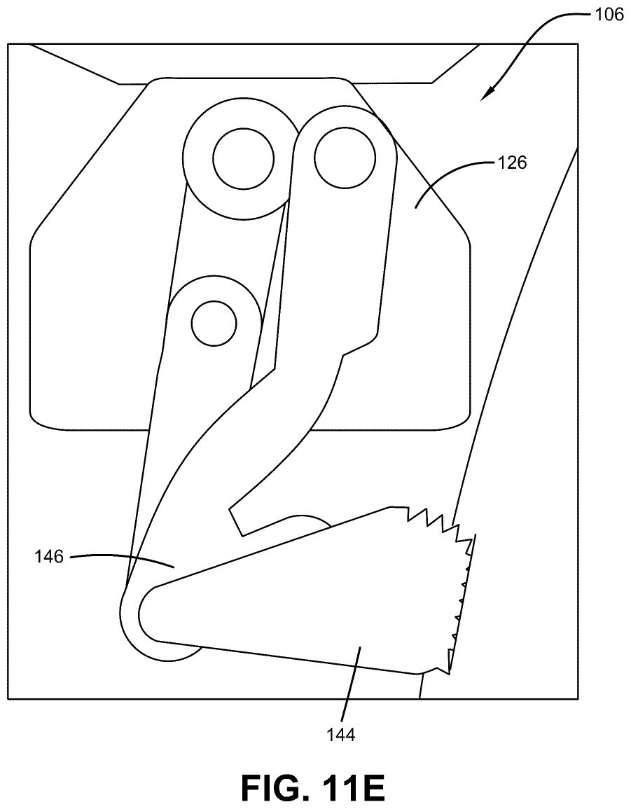

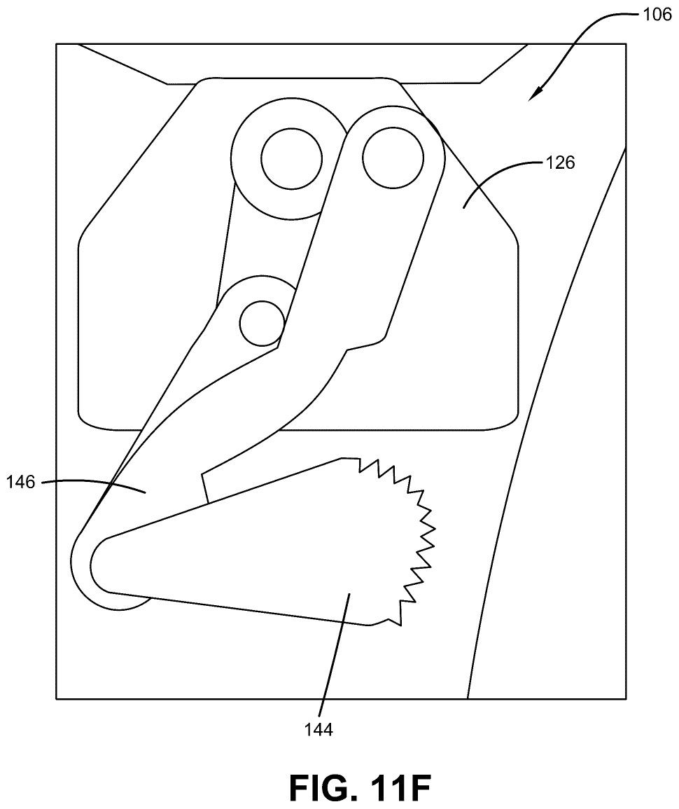

As shown in FIGS. 11A-F, in one embodiment, the brake assemblies 106 are positioned near the drive wheels 118 of the wheelchair 108 and comprise a clamp or lever 144 which engage the drive wheels 118 of the wheelchair 108. Specifically, the lever 144 pivots about a vertical axis relative to the wheelchair 108, and the lever 144 is then adapted to engage the drive wheels 118 of the wheelchair 108. To disengage, the levers 144 are then rotated downwardly into a disengaged position. The lever 144 comprises a generally arcuate shape which provides more surface contact between the lever 144 and the drive wheel 118, thereby increasing rotational resistance. Typically, only one brake assembly 106 is necessary to accomplish the desired braking function of the wheelchair 108. However, it is most common to pair a first and a second brake assembly 106 with the opposing drive wheels 118.

Further, the brake assembly 106 is motor 126 driven and has a default engaged position. In this embodiment, the motor 126 is disposed with the brake assembly 106 near the drive wheel 118. The brake assembly 106 includes a shaft 146 and a lever 144. Thus, the brake assembly 106 is in communication with a motor 126, such that the brake assembly 106 is activated when there is no electricity. This means that it doesn't take any energy to hold the motor shaft 146 still and engage the brake assembly 106, but instead it takes energy to release the motor 126 to turn the shaft 146 and disengage the brake assembly 106. This reduces energy consumption for the device 100. In the engaged position, the lever 144 of the brake assembly 106 is disposed adjacent to and confronts a portion of the drive wheel 118, preventing it from rotating freely. In the disengaged position, the lever 144 is disposed a sufficient distance away from the drive wheel 118, to allow it to freely rotate. Further the brake assemblies 106 are in communication with the pressure sensitive pad 102 which detects user movement and communicates with the brake assemblies 106 to facilitate rotational movement or pivoting of the lever 144 from the engaged position toward the disengaged position when a user is entering or leaving the wheelchair 108. Accordingly, the motor 126 spins the shaft 146 clockwise and the lever 144 engages the drive wheel 118 of the wheelchair 108. Further, the motor 126 spins the shaft 146 counter-clockwise and the lever 144 disengages from the drive wheel 118. Further, by having the engaged position as the default position, the drive wheels 118 remain locked when the user is not seated, thereby immobilizing the wheelchair 108 and providing a stable structure for the user. Since the wheelchair 108 is immobilized, a user entering or leaving the seat 112 of the wheelchair 108 will have a significantly reduced chance of falling due to the wheelchair 108 coming out from under them.

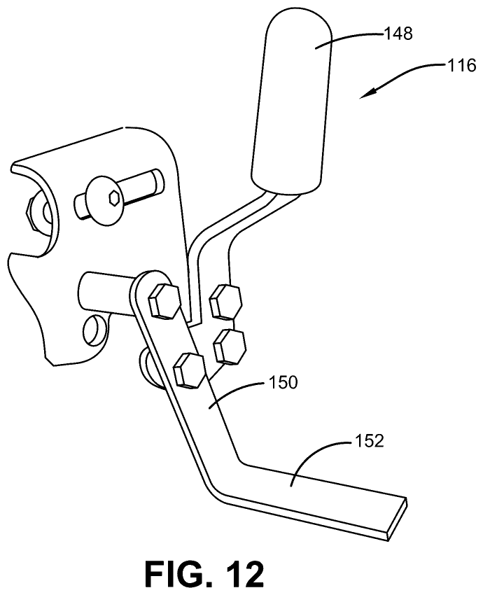

As shown in FIG. 12, the self-locking wheelchair device 100 comprises a manual brake mechanism 116 which allows either a user or an attendant to manually lock the wheels 118 of the wheelchair 108 when exiting, so that the wheelchair 108 does not move away when a patient attempts to enter or exit. For example, if the device 100 does not activate and/or does not engage the brake assemblies 106, the manual brake mechanism 116 can be engaged to override the automatic brake assemblies 106. A user merely turns the handle 148 which turns the shaft 150 (instead of the motor 126 turning it) to engage a lever 152 which engages the wheel 118 to prevent the wheelchair 108 from moving.

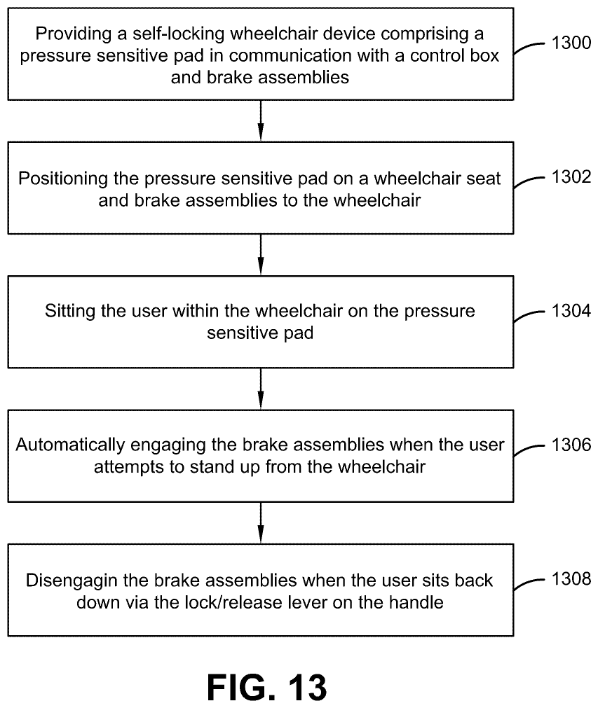

FIG. 13 illustrates a flowchart of the method of automatically locking a wheelchair when a user attempts to stand. The method includes the steps of at 1300, providing a self-locking wheelchair device comprising a pressure sensitive pad in communication with a control box and brake assemblies. The method also comprises at 1302, positioning the pressure sensitive pad on a wheelchair seat and securing the control box and brake assemblies to the wheelchair. Further, the method comprises at 1304, sitting a user within the wheelchair on the pressure sensitive pad. The method also comprises at 1306, automatically engaging the brake assemblies when the user attempts to stand up from the wheelchair. Finally, the method comprises at 1308, disengaging the brake assemblies when the user sits back down via the lock/release lever on the handle.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “self-locking wheelchair device”, “self-locking device”, “wheelchair device”, and “device” are interchangeable and refer to the self-locking wheelchair device 100 of the present invention.

Notwithstanding the forgoing, the self-locking wheelchair device 100 of the present invention can be of any suitable size and configuration as is known in the art without affecting the overall concept of the invention, provided that it accomplishes the above stated objectives. One of ordinary skill in the art will appreciate that the self-locking wheelchair device 100 as shown in FIGS. 1-13 is for illustrative purposes only, and that many other sizes and shapes of the self-locking wheelchair device 100 are well within the scope of the present disclosure. Although the dimensions of the self-locking wheelchair device 100 are important design parameters for user convenience, the self-locking wheelchair device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-locking wheelchair device that automatically locks a wheelchair when a user attempts to stand up, the self-locking wheelchair device comprising:
a pressure sensitive pad;
a control box; and
a brake assembly;
wherein the pressure sensitive pad is in communication with the control box;
wherein the control box is in communication with the brake assembly; and
further wherein when the pressure sensitive pad is activated, the control box acts to engage and disengage the brake assembly, such that when a user attempts to stand from a wheelchair, the brake assembly is automatically engaged to lock wheels of the wheelchair in place.

2. The self-locking wheelchair device of claim 1, wherein the self-locking wheelchair device is mounted to a conventional wheelchair.

3. The self-locking wheelchair device of claim 2, wherein the conventional wheelchair comprises a frame, a seat, a backrest, two large drive wheels, a pair of leg rests, and a pair of armrests.

4. The self-locking wheelchair device of claim 3, wherein the self-locking wheelchair device is movable between a first position when the wheelchair is occupied and a second position when the wheelchair is unoccupied.

5. The self-locking wheelchair device of claim 4, wherein the pressure sensitive pad is configured to fit within the seat of the wheelchair to sense when a user is entering or leaving the wheelchair.

6. The self-locking wheelchair device of claim 5, wherein the pressure sensitive pad detects when pressure is applied and removed from the pressure sensitive pad.

7. The self-locking wheelchair device of claim 6, wherein downward movement of the pressure sensitive pad causes the control box to communicate with the brake assembly to engage the drive wheels and when user is seated, the brake assembly is disengaged.

8. The self-locking wheelchair device of claim 7, wherein the control box comprises a controller and a battery, as well as a power button and charging port.

9. The self-locking wheelchair device of claim 8, wherein the pressure sensitive pad communicates with the controller, which in turn communicates with a motor and the brake assembly.

10. The self-locking wheelchair device of claim 9, wherein a handle of the wheelchair comprises at least one lock/release lever in communication with the control box to enable the brake assembly to be disengaged or engaged with the drive wheels.

11. The self-locking wheelchair device of claim 10, wherein the battery within the control box is rechargeable or replaceable and acts to power the controller and the motor.

12. The self-locking wheelchair device of claim 11, wherein any required wiring is secured to the frame of the wheelchair via Velcro straps.

13. The self-locking wheelchair device of claim 12, wherein a motor is coupled to the brake assembly and the brake assembly comprises a shaft and a lever which engages the drive wheels.

14. The self-locking wheelchair device of claim 13, wherein there are two brake assemblies, one on each drive wheel.

15. A self-locking wheelchair device that automatically locks a wheelchair when a user attempts to stand up, the self-locking wheelchair device comprising:
a pressure sensitive pad configured to fit within the seat of a wheelchair to sense when a user is entering or leaving the wheelchair;
a control box comprising a controller and a battery, as well as a power button and charging port; and
a brake assembly; and
wherein the self-locking wheelchair device is movable between a first position when the wheelchair is occupied and a second position when the wheelchair is unoccupied;
wherein the pressure sensitive pad detects when pressure is applied and removed from the pressure sensitive pad;
wherein downward movement of the pressure sensitive pad causes the control box to communicate with the brake assembly to engage the drive wheels and when user is seated, the brake assembly is disengaged;
wherein the pressure sensitive pad communicates with the controller, which in turn communicates with a motor and the brake assembly;
wherein the motor is coupled to the brake assembly and the brake assembly comprises a shaft and a lever which engages the drive wheels;
wherein when the pressure sensitive pad is activated, the control box acts to engage and disengage the brake assembly, such that when a user attempts to stand from a wheelchair, the brake assembly is automatically engaged to lock wheels of the wheelchair in place; and
further wherein a handle of the wheelchair comprises at least one lock/release lever in communication with the control box to enable the brake assembly to be disengaged or engaged with the drive wheels.

16. The self-locking wheelchair device of claim 15 further comprising a plurality of indicia.

17. The self-locking wheelchair device of claim 15, wherein the brake assembly has a default engaged position, wherein in the engaged position, the lever of the brake assembly is disposed adjacent to and confronts a portion of the drive wheel, preventing it from rotating freely.

18. The self-locking wheelchair device of claim 15, wherein in the disengaged position, the lever is disposed a sufficient distance away from the drive wheel, to allow it to freely rotate.

19. The self-locking wheelchair device of claim 15 further comprising a manual brake mechanism which allows a user to manually lock the drive wheels.

20. A method of automatically locking a wheelchair when a user attempts to stand, the method comprising the following steps:
providing a self-locking wheelchair device comprising a pressure sensitive pad in communication with a control box and brake assemblies;
positioning the pressure sensitive pad on a wheelchair seat and securing the control box and brake assemblies to the wheelchair;
sitting a user within the wheelchair on the pressure sensitive pad;
automatically engaging the brake assemblies when the user attempts to stand up from the wheelchair; and
disengaging the brake assemblies when the user sits back down via the lock/release lever on the handle.
